(19) United States
(12) Patent Application Publication
(10) Pub. No.: US 2009/0242652 A1
(43) Pub. Date: Oct. 1, 2009

(54) Power saving compressor and control logic

(75) Inventors: Kwangtaek Hong, Ann Arbor, MI (US); Bryan Styles, Livonia, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/079,136

(22) Filed: Mar. 25, 2008

(51) Int. Cl. G05D 23/00; F25B 41/00

(52) U.S. Cl. 236/46 R; 236/34.5; 236/92 B; 700/276

(57) ABSTRACT

An air conditioner control method may entail measuring an evaporator first temperature at an exit side of the evaporator, maintaining the evaporator first temperature, measuring a length of time that the evaporator maintains the evaporator first temperature, providing a user-set evaporator target temperature; and reducing a rate of refrigerant compressed by a compressor based on a relationship between the length of time that the evaporator maintains the evaporator first temperature and the evaporator target temperature. Furthermore, an air conditioner control method utilizing a condenser and a cold storage unit may entail turning off an air conditioner compressor, maintaining operation of a condenser cooling fan, closing a thermostatic expansion valve, opening a bleed port to bypass the thermostatic expansion valve, and receiving a liquid refrigerant into the cold storage unit from the condenser after the refrigerant passes through a thermostatic expansion valve bleed port and the evaporator.

### FIELD

The present disclosure relates to an air conditioning apparatus and a method of controlling the output of a vehicle air conditioning compressor based on evaporator utilization.

### BACKGROUND

The statements in this section merely provide background information related to the present disclosure and may not constitute prior art. Vehicle manufacturers are continuously striving to produce vehicles that overall, consume less energy. In many vehicles, specific components such as alternators, air-conditioning compressors, and cooling fans are driven by belts and pulleys that rely directly on rotation of the engine, which must consume extra fuel as opposed to a situation where components are not directly engine-driven. Accordingly, in vehicles utilizing internal combustion engines and engine-driven components, attention is being directed at improving the efficiency of engine-driven components to reduce fuel consumption.

Stated differently, because current air conditioning system logic does not consider controlling other operational points, or that is, other air conditioning components, when the cooling capacity of the evaporator has been reached, the compressor of a current air conditioning system will continue to try to cool or make the evaporator colder even when the capacity of the evaporator has been reached.

Cold storage is an area of technology that is being studied on mild hybrid systems. Mild hybrid systems are systems that occasionally turn off the engine and thus the air conditioning compressor but also usually do not operate the compressor solely on electrical power. Thus, increasing cold storage within the air conditioning system is sought to enable the evaporator to continue to remove heat from air passed through the evaporator even after the engine and compressor cease to operate. Utilization of cold storage to prolong evaporator utilization to achieve extended cool air from the exit side of the evaporator is sought to be accomplished using cooling fan logic. Such will make the air conditioner more efficient.

While efforts at increasing efficiencies may be directed at a variety of engine-driven components, a further need exists in the art for increasing the efficiency of air conditioning systems. More specifically, what is needed then is a vehicle air conditioning apparatus and a method of controlling the air conditioning apparatus that pertains to monitoring evaporator capacity and changing the speed and/or the displacement of the compressor according to the evaporator capacity. Additionally needed is air conditioning control logic to extend the time of blown cold air from an evaporator based upon the degree of cold storage within the air conditioning system.

### SUMMARY

An air conditioner control method may entail measuring an evaporator first temperature at an exit side of the evaporator, maintaining the evaporator first temperature, measuring a length of time that the evaporator maintains the evaporator first temperature, providing a user-set evaporator target temperature; and reducing a rate of refrigerant compressed by a compressor based on a relationship between the length of time that the evaporator maintains the evaporator first temperature and the evaporator target temperature. Furthermore, an air conditioner control method utilizing a condenser and a cold storage unit may entail turning off an air conditioner compressor, maintaining operation of a condenser cooling fan, closing a thermostatic expansion valve, opening a bleed port to bypass the thermostatic expansion valve, and receiving a liquid refrigerant into the cold storage unit from the condenser after the refrigerant passes through a thermostatic expansion valve bleed port and the evaporator.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram depicting components of a vehicle air conditioning and cooling system;

FIG. 2 is a top view of a vehicle interior depicting locations of various air conditioning components;

FIG. 3 is a flowchart depicting steps of controlling an air conditioning system;

FIG. 4 depicts air conditioning components when an air conditioner compressor is compressing;

FIG. 5 depicts air conditioning components when an air conditioner compressor is not compressing;

FIG. 6 is a graph of evaporator outlet temperature versus time for a period of time when the compressor is not operating; and

FIG. 7 is a flowchart depicting steps of controlling an air conditioning system.

### DETAILED DESCRIPTION

The following description is merely exemplary in nature and is not intended to limit the present disclosure, application, or uses. It should be understood that throughout the drawings, corresponding reference numerals indicate like or corresponding parts and features. Turning to the present teachings, cold storage is an area of air conditioner technology that may be utilized or implemented on mild hybrid vehicles. A mild hybrid vehicle is a type of vehicle that normally is not configured to operate its air conditioning compressor solely from electrical power when the internal combustion engine is not operating, as in a “full hybrid” type of vehicle, because of cost constraints. Therefore, the air conditioning compressor on a mild hybrid vehicle is typically only operated from mechanical energy from the engine when the engine is operating and when the engine is not operating, the compressor does not function. Alternatively, an electric compressor may be employed, but this again imposes cost constraints. Concerning mild hybrid vehicles, it remains a desire to prolong the cold air that is available from the exit side of the evaporator for as long as possible, including during periods of time when the engine is not functioning. Thus, ways of utilizing an air conditioning cold storage container on the vehicle is desired. As is known in the field of vehicle air conditioning, cold storage may be accomplished using a type of wax, such as paraffin that freezes and remains cold until it is needed. Utilizing cold storage containers may also have a savings associated with them that are not possible with different arrangements of different types of compressors and ways of powering such compressors when an engine is not operating.

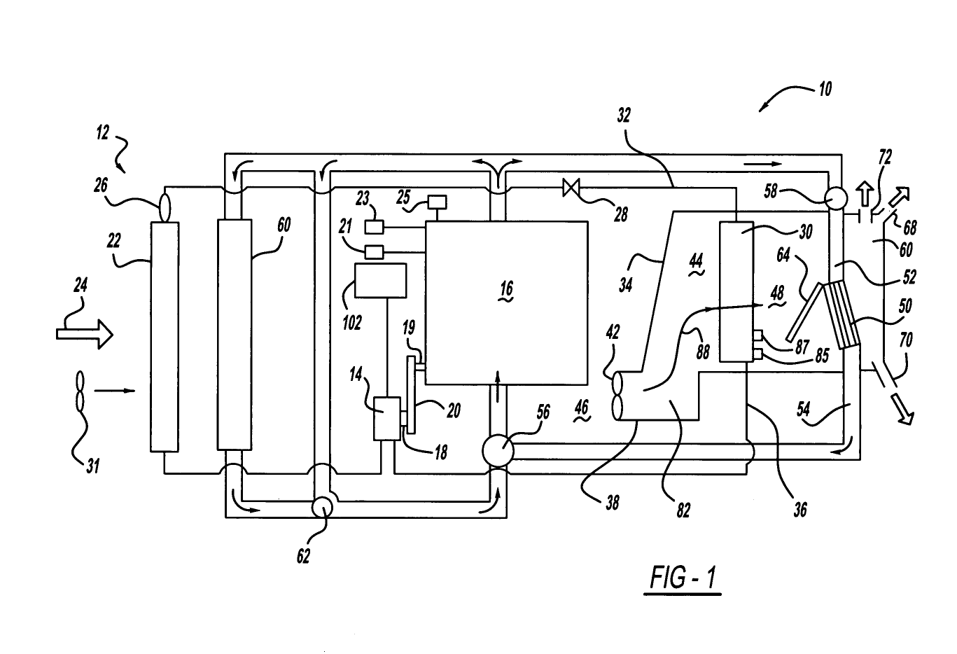

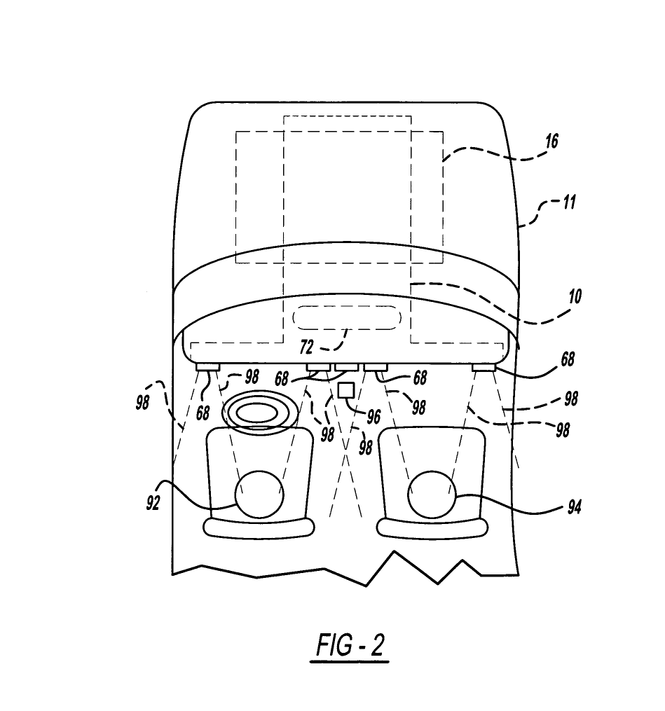

Turning now to FIGS. 1 and 2, details of the teachings of the present invention will be discussed. With initial reference to FIG. 1, a block diagram of a conventional vehicle heating, ventilating and air-conditioning system (“HVAC”) system 10 is depicted, which may be resident in a vehicle 11. A refrigeration cycle of the vehicle HVAC system 10 includes an air-cooling system 12. The air-cooling system 12 includes a compressor 14 which draws, compresses, and discharges, or pumps, a refrigerant. The power of a vehicle engine 16 is transmitted to the compressor 14 through pulley 18, pulley 19 and a belt 20. The vehicle engine 16 drives not only the air conditioning compressor 14 but also such auxiliaries as an electricity generator or alternator 21, a power steering unit hydraulic pump 23, and a coolant or water pump 25 via belts, shafts, chains and other power transmitting devices.

In a refrigeration cycle, the compressor 14 discharges a superheated gas refrigerant of high temperature and high pressure, which flows into a condenser 22. In the condenser 22, heat exchange is performed with the outside air 24, which may be assisted or driven by a cooling fan 31, which normally blows forced air 29 at a higher velocity than the outside air 24, so that the refrigerant is cooled to undergo condensing. The refrigerant condensed in the condenser 22 then flows into a receiver 26, in which the refrigerant is separated into a gas and a liquid. A redundant liquid refrigerant in the refrigeration cycle is stored inside the receiver 26. The liquid refrigerant from the receiver 26 is decompressed by an expansion valve 28 into a gas-liquid double phase state of low pressure refrigerant. The low pressure refrigerant from the expansion valve 28 then flows into an evaporator 30 by way of an inlet pipe 32. The evaporator 30 is arranged inside an HVAC case 34 of the HVAC system 10. The low pressure refrigerant flowing into the evaporator 30 absorbs heat from the air inside the HVAC case 34 during evaporation. An outlet pipe 36 of the evaporator 30 is connected to the suction side of the compressor 14 so that the cycle components mentioned above constitute a closed circuit.

Continuing with FIGS. 1 and 2, the HVAC case 34 forms a ventilation duct 38 through which air conditioning air is sent into the vehicle cabin or passenger compartment 40. The HVAC case 34 contains a blower or fan 42 that may be arranged on the upstream side 46 of the evaporator 30. An inside/outside air switch box (not shown) may be arranged on the suction side 46 of the fan 42 (left of the fan 42 as viewed from FIG. 1). The air inside the passenger compartment 40 (inside air) or the air outside the passenger compartment 40 (outside air) switched and introduced through the inside/outside air switch box is sent into the HVAC case 34 through the entrance duct 38 by the fan 42.

The HVAC case 34 accommodates, on the downstream side 48 of the evaporator 30, a hot water heater core 50 to exchange heat with air passing through the heater core 50. The heater core 50 includes an inlet pipe 52 and an outlet pipe 54. An engine coolant, such as water or an antifreeze solution that circulates around the vehicle engine 16, is directed to the heater core 50 through the inlet pipe 52 by a water pump 25. A water valve 58 controls the flow volume of engine coolant supplied to the heater core 50. A radiator 60 and a thermistor 62 further cooperate to control the temperature of the flowing coolant.

A bypass channel 66 exists beside the hot water heater core 46 in the HVAC case 34. An air mix door 64 is provided to adjust the volume ratio between warm air and cool air that passes through the hot water heater core 50 and the bypass channel 66, respectively. The air mix door 64 adjusts the temperature of the air blown into the passenger compartment 40 by adjusting the volume ratio between the warm air and cool air.

Additionally, a face outlet 68, a foot outlet 70, and a front windshield defroster outlet 72 are formed at the downstream end of the HVAC case 42. The face outlet 68 directs air toward the upper body portions of passengers, the foot outlet 70 directs air toward the feet of the passengers, and the defroster outlet 72 directs air toward the internal surface of a windshield. The outlets 68, 70 and 72 are opened and closed by outlet mode doors (not shown). The air mix door 64 and the outlet mode doors mentioned above are driven or adjusted by electric driving devices such as servo motors via linkages or the like.

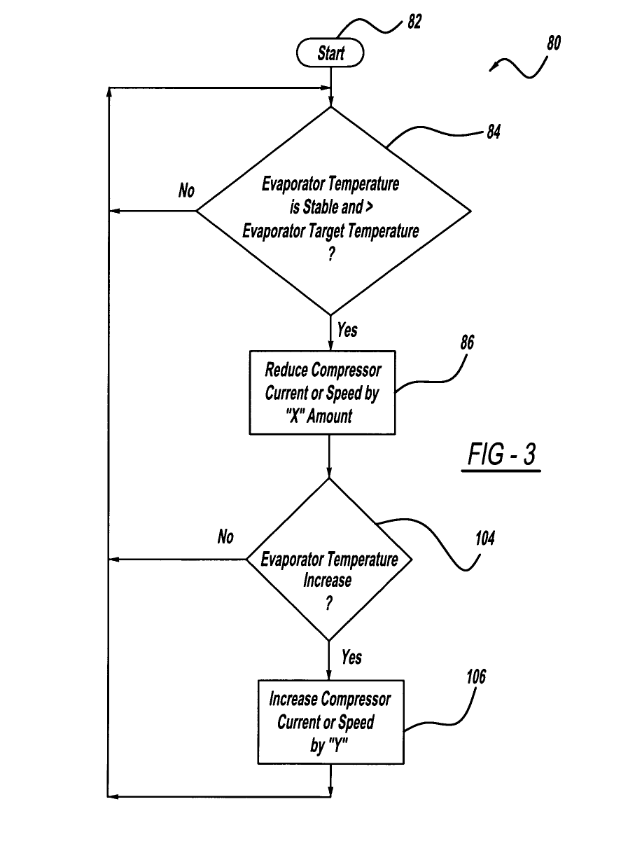

With the inclusion of FIG. 3, a control method 80 of an HVAC system 10 in accordance with the present disclosure will be provided. The control method 80 may be employed in the HVAC system 10 as described above, as will be evident by reference to such in the explanation that follows. Beginning with the start bubble 82, the routine proceeds to inquiry block 84 to inquire whether the evaporator temperature is stable and greater than the evaporator target temperature. The evaporator temperature may be measured in more than one way. For instance, a thermistor 85, which is a resistor whose resistance varies in accordance with its temperature, may be used to measure the temperature of the evaporator 30, such as at the airflow exit surface of the evaporator 30. Similarly, a resistance temperature detector 87 may be used to measure the temperature at the airflow exit surface of the evaporator 30. Resistance temperature detectors differ from thermistors in that the material used in a thermistor is generally a ceramic or polymer, while resistance temperature detectors use pure metals. Still yet, a temperature probe may be used to measure the temperature of the airflow 88 on the exit side of the evaporator 30, such as at the evaporator surface, or immediately aft of the evaporator surface, such as within inches from the exit side of the evaporator surface. Therefore, the evaporator temperature may be measured on the evaporator surface or within the airflow 88, within inches of the evaporator surface.

Continuing with the inquiry at inquiry block 84, if the evaporator temperature is stable, that is consistent and not changing, and the evaporator temperature is greater than the evaporator target temperature, the flow of the control logic proceeds to inquiry block 86. However, if the evaporator temperature is not stable or if the evaporator target temperature is equal to or less than the evaporator target temperature, then the flow of control logic returns to the beginning and re-enters inquiry block 84. Generally, a reason for inquiring as to whether the evaporator temperature is stable is to prevent the deliberate changing of anything in the HVAC system 10, such as regarding operation of the air conditioning compressor 14, until the change has been completed. To determine a stable evaporator temperature, a time period, such as 10 seconds, 30 seconds, 1 minute, etc. may be set for maintaining such a temperature in order for the evaporator temperature to be considered stable. Continuing, the HVAC system has a target panel-air 68 temperature that is set by a vehicle operator 92 or other passenger 94 on an air conditioning panel 96 within the passenger compartment 40. Setting the target air temperature sets or fixes the temperature of the blowing air 98 that exits from the vents 68 or exit ports 68 within the passenger compartment 40 after the blowing air has passed through the evaporator 30 as airflow 88.

Therefore, setting a temperature on the air conditioning panel 96 adjusts the degree of work or compression of the compressor 14. Stated differently and in terms of the compressor 14, the compressor 14 compresses more or less refrigerant depending upon the temperature/amount of the air to be blown from the vents 68. By adjusting the degree of work or compression of the compressor 14 with respect to the refrigerant compressed, the amount and/or rate of refrigerant passing through the evaporator varies, as well as its temperature in the evaporator.

At block 86, upon the reply to the inquiry at block 84 being “yes,” a control unit 102 in communication with the compressor 14 adjusts or effects a change in the electrical current supplied to the compressor 14, if the compressor is electrically controlled, or adjusts the stroke or displacement of the piston that does the compression or pumping of the refrigerant in the compressor 14.

After the compression of the compressor 14 is adjusted (i.e. lessened or reduced in output) by control of the control unit 102, inquiry block 104 inquires whether the evaporator temperature has increased (become warmer) since the compression of the compressor 14 was adjusted. If the evaporator temperature has not increased, then the control returns to the inquiry block 84 to again make the inquiry as to whether the evaporator temperature is stable and greater than the evaporator target temperature. However, if the evaporator temperature has increased (become warmer), then control proceeds to block 106. At block 106, the compressor speed (current) is increased by the control unit 102 if the compressor 14 is an electric compressor, or alternatively, the current into the compressor may be increased or changed if it is a mechanical compressor 14 that has a swash plate, which is changed electrically in conjunction with a control valve. The mechanically driven compressor 14, such as driven by pulleys 18, 19, may be driven by the engine. Upon making the adjustment (increase in current or speed) of the compressor 14, the evaporator temperature may be decreased, thus resulting in colder air being discharged from the vents 68 as panel air 68.

By using the above control logic, the work or compression of the compressor is controlled so that the compressor output or work does not exceed the evaporator capacity. Stated differently, the control logic of the present disclosure permits the compressor 14 to be used only up to the cooling capacity of the evaporator 30. By preventing the compressor 14 from compressing faster or from compressing additional refrigerant when the evaporator can not be cooled or lowered in temperature, as measured at the evaporator surface, vehicle energy is conserved. Conserving vehicle energy may mean conserving gasoline that the internal combustion engine is consuming to provide the energy necessary to operate a belt-driven external—variable displacement compressor (E-VDC) at high capacity when such capacity is actually not necessary at the time that the air conditioning evaporator has reached its cooling capacity. Alternatively, in the event of an electrically driven compressor, the electric compressor may reduce its rpm, and thus capacity, at the time that the air conditioning evaporator has reached its maximum cooling capacity. A feature of the control logic is that it takes into consideration operational points where the evaporator capacity has been reached and it reduces compressor power consumption in order to reduce engine fuel consumption during periods when the compressor is run at excess capacity, which is when the evaporator capacity has been reached for example. This strategy actively reduces compressor capacity to match that of the limiting factor, to performance, in the system.

In order to effectively control the compressor in accordance with the logic disclosed, the control unit 102 may be in communication with the compressor 14, whether it is an electric compressor or a belt-driven E-VDC compressor, the thermistor 85, the resistance temperature detector 87, and the evaporator surface 90 to determine a temperature associated with the evaporator 30. Continuing, the controller 102 may also be capable of tracking time intervals between temperature readings.

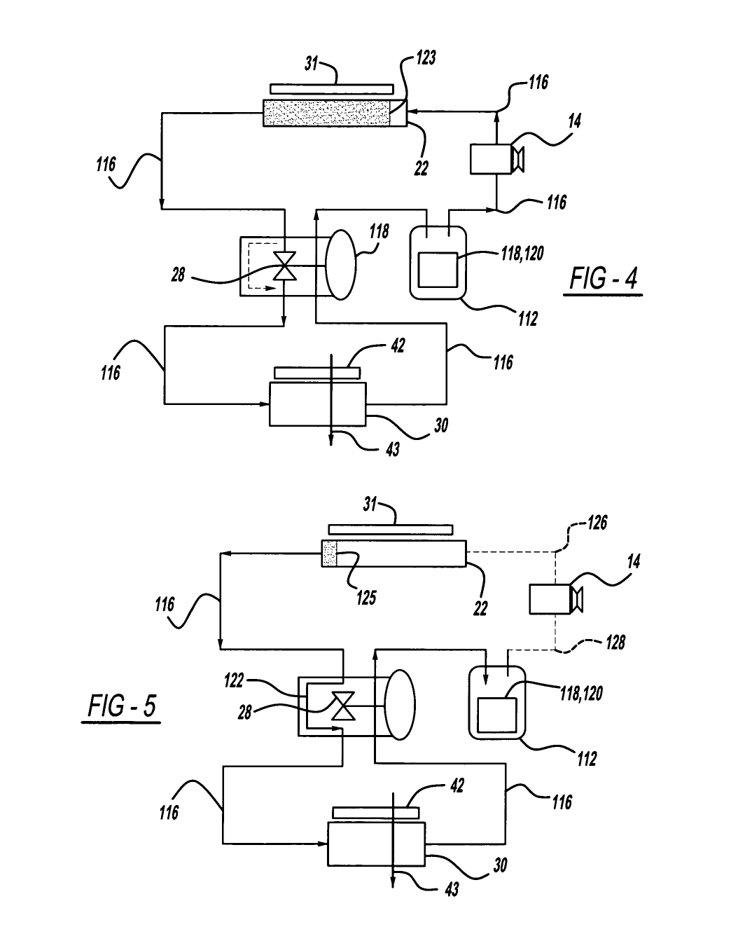

Continuing now with reference to FIGS. 4 and 5, the components of an air conditioning system 110 and their use to increase air conditioner efficiency when the engine is turned off will be described. FIGS. 4 and 5 depict air conditioning components, as presented in FIG. 1, such as a compressor 14, a condenser 22, an evaporator 30, a condenser cooling fan 31, and expansion valve 28, also known as a thermal expansion valve. Additionally, because the air conditioning system 110 depicted in FIGS. 4 and 5 is one that may be used on a mild hybrid vehicle, a cold storage unit 112 and a bleed orifice 114, also called a bypass orifice 114, may be utilized. The bleed orifice 114 is essentially a fixed orifice that bypasses the expansion valve 28, also known as a “TXV” 28 or “thermal expansion valve” 28.

FIG. 4 depicts a system in which the air conditioning system 110 functions with the engine operating to drive an engaged compressor 14 to condense refrigerant that circulates in the loop depicted with solid arrows 116. With the air conditioning system 110 functioning, the TXV 28 also functions. More specifically, the TXV 28 is a temperature type of expansion valve that reduces the pressure of the liquid phase refrigerant from the condenser 22 to expand the liquid phase refrigerant in an isenthalpic manner and includes a valve part and a temperature sensing part 118, which may be arranged on the refrigerant outflow side of the evaporator 30. With the temperature sensing part 118 arranged between the evaporator 30 and the cold storage container 112. A throttle opening part of the TXV 28 may be controlled according to a refrigerant temperature sensed by the temperature sensing part of the TXV 28. Such control may bring the degree of superheat of the refrigerant flowing out of the evaporator 30 to a specified value (for example, from 5 degrees C. to 10 degrees C.).

Continuing with the system 110 of FIG. 4, the cold storage unit or tank 112 is located between the evaporator 30 and the compressor 14 so as to be in series with the evaporator 30. Within the cold storage tank 112, a cold storage material 118 resides, such as a wax or wax-like material as examples. Additionally, a cold storage heat exchanger 120 may reside within the cold storage tank 112. The cold storage heat exchanger 120 is a heat exchanger that causes refrigerant flowing out of the evaporator 30 in the tube indicated by solid arrow 116 to be introduced into the cold storage unit 112 and exchange heat between the refrigerant and the cold storage material in the cold storage unit 112. The process of the cold storage unit 112 exchanging heat and becoming colder with the compressor 14 compressing is known as “charging.” As depicted in FIG. 4, the condenser 22 is filled with liquid refrigerant to a degree, as indicated by the volume 122.

Turning now to FIG. 5, the air conditioning system 110 of FIG. 4 is depicted, although the system 110 depicted in FIG. 5 functions under different operating parameters or conditions, yet consistent with those that may be applicable to a mild hybrid system of a vehicle. FIG. 5 depicts a discharging process in which the internal combustion engine 16 that drives the compressor 14 with rotational motion is off and thus, the compressor 14 ceases to operate which ceases compression by the compressor 14. Thus, when the system 110 has its compressor turned off, the system 110 is in a discharge mode, and higher pressure from the high pressure side of the system (between the condenser 22 and the TXV inlet), and lower pressure from the low pressure side of the system (between the evaporator and the cold storage unit 112), will begin to balance. In taking advantage of such a pressure differential, teachings of the present disclosure are directed to increasing the amount and time that liquid refrigerant may be drawn from the condenser 22, through a bleed port 122 to bypass the TXV 28, through the evaporator 30, and into the cold storage unit 112, even after the engine 16 and compressor 14 are turned off. Such may be done in conjunction with maintaining operation of the condenser cooling fan 31. Such movement of liquid refrigerant is possible because of the pressure differential that exists between the condenser 22 and the cold storage unit 112 just after the compressor 14 is turned off. More specifically, movement of liquid refrigerant occurs because the pressure is greater in the condenser 22, which is on the high pressure side of the system, than in the cold storage unit 112, which is on the low pressure side of the system 110.

Continuing, because the tubes through which refrigerant travels, as depicted by arrows 116, create a closed loop within the air conditioning system, any liquid refrigerant 124 in the condenser 22 may still be drawn through the tubes to the evaporator 30. Thus, maximizing the amount of liquid condensate present in the system, that is, increasing the amount of liquid refrigerant, after the engine 16 and compressor 14 are turned off and getting the condensate to the evaporator 30 may be accomplished by utilizing the volume of cold storage in the cold storage unit 112.

With continued reference to FIG. 5, when the compressor 14 is turned off, the compressor 14 essentially creates a block in the refrigerant line as nothing passes through the compressor 14 after it has been turned off. Therefore, between the condenser 22 and the compressor 14, refrigerant ceases to flow in the refrigerant line 126 and between the compressor 14 and the cold storage unit 112, refrigerant ceases to flow in the refrigerant line 128. However, because the contents of the cold storage unit 112 remain cold for a period of time after the compressor 14 ceases to compress, the heat transfer created by such cold storage can be used to draw remaining liquid refrigerant from the condenser 22. Additionally, even after the engine 16 and compressor 14 are turned off, the cooling fan 31 may remain turning to provide airflow through the condenser 22. By continuing the operation of the cooling fan 31, heat may continue to be removed from the condensed refrigerant in the condenser 22. At the same time, because the mass of cold storage material 118 in the cold storage unit 112 is at a temperature, for example, of 5 degrees Celcius to 10 degrees Celcius, condensed refrigerant will continue to be drawn from the condenser 22, through the tubes 116, and into the evaporator 30 so that the fan 42 may continue to blow forced air 43 through the evaporator 30. By continuing to draw liquid refrigerant 124 from the condenser 22 and into the evaporator 30, and blowing forced air 43 through the evaporator 30, vehicle occupants within a vehicle cabin 40 may continue to enjoy air conditioned air, even after the compressor 14 and engine 16 have been turned off. Such may be the case in a mild hybrid vehicle whose engine 16 and compressor 14 are turned off at a red light at an intersection or for example, if a vehicle is in stop and start traffic, such as in a traffic jam.

To facilitate the drawing of liquid refrigerant from the condenser 22 and into the evaporator 30, a bleed port 122 or bypass tube 122 may be utilized in place of the TXV 28. Such bleed port 122 or bypass tube 122 will automatically open and thereby prevent the TXV 28 from being utilized when the engine is turned off. Stated differently, the TXV 28 is not utilized when the engine 16 and compressor 14 are turned off. As the cold storage unit 112 continues to draw liquid refrigerant from the condenser 22 and into the evaporator 30, the amount of liquid refrigerant 123 in the condenser 22 decreases, as depicted in viewing the amount of liquid refrigerant 123 in FIG. 4 and the amount of liquid refrigerant 125 in FIG. 5.

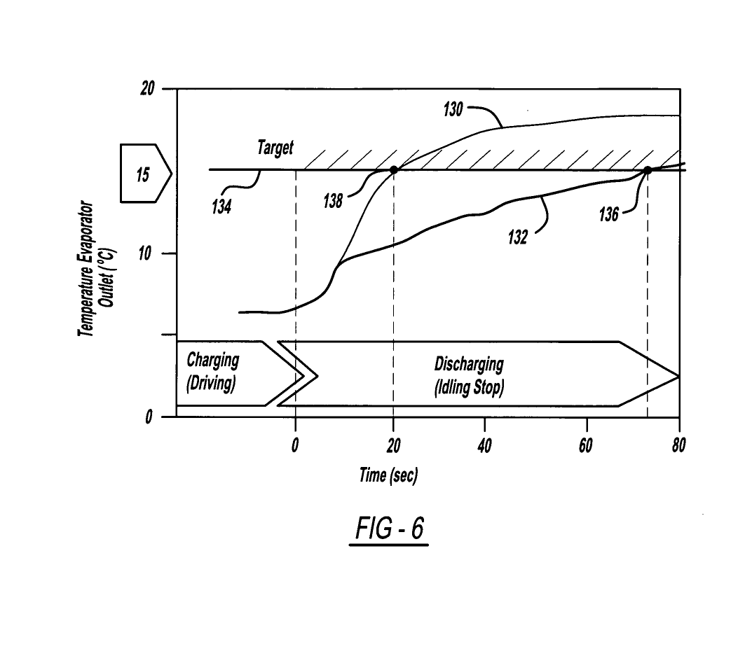

Turning now to FIG. 6, the effects of the teachings of the present disclosure will be described. FIG. 6 depicts plots of Evaporator Outlet Temperature (Celsius) versus Time (seconds) when an air conditioner compressor 14 is not operating. The “Target” Plot 130 depicts a plot of a traditional, typical vehicle air conditioner system in which the compressor stops when the engine stops. That is, no further transfer of refrigerant occurs upon turning the engine off. Furthermore, no air conditioning cold storage unit is utilized. Plot 132 depicts the projected effects of the vehicle air conditioning system of the present disclosure. More specifically, the plot 132 crosses the target temperature level 134 at the point 136 while in a traditional air conditioning system with no cold storage the plot 130 crosses the target temperature level 134 at 138. As depicted, the teachings of the present disclosure result in an increase of blown cold air within the passenger compartment 40 of approximately more than 40 seconds. More specifically, at time 0 seconds, the vehicle engine 16 may be turned off. Approximately 20 seconds later as indicated at a time of 20 seconds, the target temperature line 134 is crossed by the plot 130; however, the plot 132 of the present teachings crosses the target temperature line 134 at some time beyond 60 seconds. Therefore, the teachings of the present invention provide a significant amount of additional time (more than 40 additional seconds) of blown air, at or below the target temperature of 15 degrees Celcius, within the vehicle compartment for vehicle occupants to enjoy.

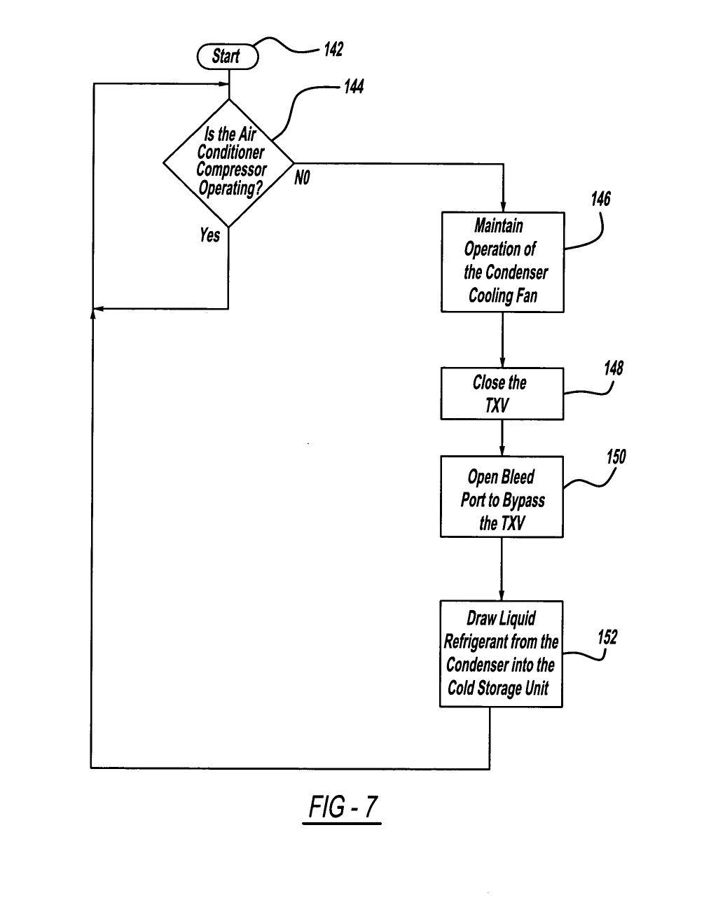

To achieve the results depicted in FIG. 6, the control logic 140 of FIG. 7 begins at start block 142 and progresses to inquiry block 144 which inquires if the air conditioning compressor is operating. If the air conditioning compressor is operating, then the inquiry simply returns onto itself until the result of the inquiry is “no.” When the result of the inquiry at inquiry block 144 is “no,” the control proceeds to block 146 where the operation of the condenser cooling fan is maintained. By maintaining operation of the condenser cooling fan 31, liquid refrigerant in the condenser 31 continues to be transformed from any refrigerant vapor in the condenser 31 and the liquid refrigerant continues to be cooled by the blown air from the fan 31. Continuing to block 148, the TXV valve 28 is closed, and then block 150 where the bleed port 122 or bypass tube 122 is opened to permit the liquid refrigerant in the refrigerant tubes between the condenser 22 and the evaporator 30 to continue to flow. Then at block 152 liquid refrigerant is drawn from the condenser 22 through the evaporator 30 and into the cold storage unit to provide continued flow of refrigerant into the evaporator 30 after the compressor 14 has been turned off or disengaged, such as upon turning off an engine.

Therefore, in addition to the above disclosure, an air conditioner control method 80 may entail measuring an evaporator first temperature at an exit side 48 of the evaporator 30, maintaining the evaporator first temperature, measuring a length of time, such as with the controller 102, that the evaporator 30 maintains the evaporator first temperature, providing a user-set evaporator target temperature, and reducing or changing a rate of refrigerant compressed by a compressor 14 based on a relationship between the length of time that the evaporator 30 maintains the evaporator first temperature and the evaporator target temperature.

The method may further entail reducing the rate of refrigerant compressed by the compressor 14 when the length of time that the evaporator 30 maintains the evaporator first temperature is at or above a predetermined time and greater than the evaporator target temperature. Still yet, the method of control may entail measuring an evaporator second temperature at an exit side of the evaporator, and comparing the evaporator second temperature and the evaporator first temperature, and then increasing the rate of refrigerant compressed by the compressor when the measured evaporator second temperature is greater than the evaporator first temperature.

Reducing a rate of refrigerant compressed by a compressor based on a relationship between the length of time that the evaporator maintains the evaporator first temperature and the evaporator target temperature may entail reducing electrical energy to the compressor 14 if the compressor is an electrically powered compressor 14. Alternatively, in the event that the compressor is not electrically powered, but rather belt driven and engaged by a clutch, for example, the length of time that a clutch of the compressor is engaged, to drive the compression of the compressor, may be altered to alter the length of time that the compressor compresses.

Still yet, an air conditioner control method 80 may entail measuring an evaporator first temperature at an exit side 48 of the evaporator 30, measuring a length of time that the evaporator 30 maintains the evaporator first temperature, providing a user-set evaporator target temperature, reducing a rate of refrigerant compressed by the compressor 14 when the length of time that the evaporator maintains the evaporator first temperature is at or above a predetermined time and greater than the evaporator target temperature, measuring an evaporator second temperature at an exit side 48 of the evaporator 30, comparing the evaporator second temperature and the evaporator first temperature, and increasing the rate of refrigerant compressed by the compressor 14 when the measured evaporator second temperature is greater than the evaporator first temperature.

The evaporator 30 reaches its cooling capacity when increasing the rate of refrigerant compression does not lower the temperature of the evaporator 30, for instance, at an exit side of the evaporator 30. Additionally, the evaporator 30 may be said to reach its cooling capacity when, after operating the compressor 14 continuously, the evaporator 30 reaches a temperature measured at an exit side (such as in the air within approximately three inches of the evaporator exit surface) or at an exit surface of the evaporator 30 below which a lower temperature is not possible to achieve. Stated differently, additional compression of the compressor 14 such as operating the compressor 14 at a determined rate for extended periods of time (including continuously) or increasing the flow rate of refrigerant compression for a period of time, does not result in a lower evaporator surface temperature or lower temperature measured at the exit side of the evaporator 30.

In another control method of an air conditioner, a cold storage unit 112 may be utilized. The method may entail terminating operation of an air conditioner compressor 14, such as by turning off an internal combustion engine 16, which powers the compressor 14, maintaining operation of a condenser cooling fan 31, closing a thermostatic expansion valve 28, and opening a bleed port 122 as a bypass of the thermostatic expansion valve 28. Furthermore, the air conditioner control method may entail receiving liquid refrigerant into the evaporator 30 from the condenser 22, or receiving liquid refrigerant into the evaporator 30 from the condenser 22 after the liquid refrigerant passes through a bleed port 122 to bypass the thermostatic expansion valve 28. Alternatively, the control method may entail forcing a liquid refrigerant from a condenser 22 at a first pressure into a cold storage unit 112 at a second pressure, such that the first pressure is higher than the second pressure. The liquid refrigerant may pass through a bleed port 122 that bypasses the thermostatic expansion valve 28 and then into an evaporator 30 before the liquid refrigerant is forced into the cold storage unit 112.

In another example of a method of controlling an air conditioner that utilizes a condenser 22 and a cold storage unit 112, the compressor 14 may be turned off, such as by turning off the engine that mechanically powers the compressor 14. Upon turning off the compressor 14, the condenser cooling fan 31 or fans would continue to operate (spin and blow air) to continue to cool the liquid refrigerant 124 within the condenser 22. Additionally, the closing of a thermostatic expansion valve 28 would occur and the opening of a bleed port 122 to bypass the thermostatic expansion valve 28 would occur. Opening of the bleed port 122 would permit liquid refrigerant to flow through the bleed port 122 or passage without having to pass through the TXV 28. Next, because the pressure in the condenser 22, upon turning off the compressor 14, would be higher than that within the evaporator 30 or cold storage unit 112, the condenser 22 would force, due to the higher pressure, a volume of the liquid refrigerant 124 in the condenser 22 through the bleed port 122, through the evaporator 30, and into the cold storage unit 112. That is, the refrigerant would be received in the cold storage unit from the condenser 22 because of the pressure differential between the condenser 22 and the cold storage unit 112 forces such a flow of the refrigerant 124. Liquid refrigerant would not flow past the cold storage unit 112, such as to the compressor 14, when the compressor 14 is not compressing.

What is claimed is:

1. An air conditioner control method comprising:
measuring an evaporator first temperature at an exit side of the evaporator;
maintaining the evaporator first temperature;
measuring a length of time that the evaporator maintains the evaporator first temperature;
providing a user-set evaporator target temperature; and
reducing a rate of refrigerant compressed by a compressor based on a relationship between the length of time that the evaporator maintains the evaporator first temperature and the evaporator target temperature.

2. The method of control of claim 1, further comprising:
reducing the rate of refrigerant compressed by the compressor when the length of time that the evaporator maintains the evaporator first temperature is at or above a predetermined time and greater than the evaporator target temperature.

3. The method of control of claim 1, further comprising:
measuring an evaporator second temperature at an exit side of the evaporator; and
comparing the evaporator second temperature and the evaporator first temperature.

4. The method of control of claim 1, further comprising:
increasing the rate of refrigerant compressed by the compressor when the measured evaporator second temperature is greater than the evaporator first temperature.

5. The method of control of claim 1, wherein reducing a rate of refrigerant compressed by a compressor based on a relationship between the length of time that the evaporator maintains the evaporator first temperature and the evaporator target temperature further comprises reducing electrical energy to the compressor.

6. The method of control of claim 1, wherein reducing a rate of refrigerant compressed by a compressor based on a relationship between the length of time that the evaporator maintains the evaporator first temperature and the evaporator target temperature further comprises reducing a length of time that the compressor compresses.

7. An air conditioner control method comprising:
measuring an evaporator first temperature at an exit side of the evaporator;
measuring a length of time that the evaporator maintains the evaporator first temperature;
providing a user-set evaporator target temperature;
reducing a rate of refrigerant compressed by the compressor when the length of time that the evaporator maintains the evaporator first temperature is at or above a predetermined time and greater than the evaporator target temperature;
measuring an evaporator second temperature at an exit side of the evaporator;
comparing the evaporator second temperature and the evaporator first temperature; and
increasing the rate of refrigerant compressed by the compressor when the measured evaporator second temperature is greater than the evaporator first temperature.

8. The air conditioner control method of claim 7 further comprising:
reducing compressor current when the temperature requested by a user is not being met and evaporator target temperature is greater than a target temperature.

9. An air conditioner control method utilizing a cold storage unit, the method comprising:
terminating operation of an air conditioner compressor;
maintaining operation of a condenser cooling fan after terminating operation of the air conditioner compressor;
closing a thermostatic expansion valve; and
opening a bleed port as a bypass of the thermostatic expansion valve.

10. The air conditioner control method of claim 9, further comprising:
receiving liquid refrigerant into the evaporator from the condenser.

11. The air conditioner control method of claim 9, further comprising:
receiving liquid refrigerant into the evaporator from the condenser after the liquid refrigerant passes through a bleed port to bypass the thermostatic expansion valve.

12. The air conditioner control method of claim 9, further comprising:
forcing a liquid refrigerant from a condenser at a first pressure into a cold storage unit at a second pressure, wherein the first pressure is higher than the second pressure.

13. The air conditioner control method of claim 9, wherein the liquid refrigerant passes through a bleed port to bypass the thermostatic expansion valve and then an evaporator before the liquid refrigerant is forced into the cold storage unit.

14. An air conditioner control method utilizing a condenser and a cold storage unit, the method comprising:
turning off an air conditioner compressor;
maintaining operation of a condenser cooling fan;
closing a thermostatic expansion valve;
opening a bleed port to bypass the thermostatic expansion valve;
receiving a liquid refrigerant into the cold storage unit from the condenser after the refrigerant passes through a thermostatic expansion valve bleed port and the evaporator.

15. The air conditioner control method of claim 14, wherein receiving the liquid refrigerant into the cold storage unit is governed by a pressure in the condenser that is higher than a pressure in the cold storage unit.
